(19) United States
(12) Patent Application Publication
(10) Pub. No.: US 2013/0054157 A1
(43) Pub. Date: Feb. 28, 2013

(54) MEASUREMENT OF PARAMETERS LINKED TO THE FLOW OF FLUIDS IN A POROUS MATERIAL

(71) Applicants: Didier Lasseux, Cestas (FR); Yves Jannot, Troussey (FR)

(72) Inventors: Didier Lasseux, Cestas (FR); Yves Jannot, Troussey (FR)

(73) Assignees: CENTRE NATIONAL DE LA RECHERCHE SCIENTIFIQUE- CNRS, Paris (FR); TOTAL SA, Courbevoie (FR)

(21) Appl. No.: 13/574,300

(22) PCT Filed: Jan. 21, 2011
(86) PCT No.: PCT/FR2011/050123

§ 371 Date: Nov. 7, 2012

(30) Foreign Application Priority Data
Jan. 22, 2010 (FR) 10 50437

(51) Int. Cl. G01N 15/08; G06F 19/00

(52) U.S. Cl. 702/47

(57) ABSTRACT

A method in which a sample of the material to be studied is placed in a sealed cell such that the upstream surface communicates with a first space (V₀) and the downstream surface communicates with a second space. The pressure in the first space is modulated and the variations over time of the respective pressures in the first space and in the second space are measured. By means of a differential equation taking as parameters the intrinsic permeability of the material, the porosity and the Klinkenberg coefficient thereof, the pressure variations measured are digitally analysed to estimate at least the intrinsic permeability and the Klinkenberg coefficient of the material, and advantageously the porosity of the material during the same experiment.

### PRIORITY CLAIM

The present application is a National Phase entry of PCT Application No. PCT/FR2011/050123, filed Jan. 21, 2011, which claims priority from French Application No. 10 50437, filed Jan. 22, 2010, the disclosures of which are hereby incorporated by reference herein in their entirety.

### FIELD OF THE INVENTION

The invention relates to the measurement of physical properties related to the flow of a fluid phase in a porous material. It applies in particular to materials which have drainage channels with very small diameters at the pore scale, i.e. materials having great resistance to the flow of a fluid (inverse of intrinsic permeability). Examples of this include, but are not limited to, rock from tight gas reservoirs, covering layers of potential storage sites, materials used in waterproofing devices, composite materials, etc.

### BACKGROUND OF THE INVENTION

The flow of a fluid through a porous medium, at the level of a representative block of material, depends on three intrinsic physical characteristics which are:
its liquid (or intrinsic) permeability k₁, expressed in m² or more commonly in D (darcy: 1 D≈0.987×10⁻¹² m²);
its Klinkenberg coefficient b, expressed in Pa, for a low-permeability medium and a low-pressure gas flow, or its Forchheimer coefficient β, expressed in m⁻¹, also called inertial resistance factor, for high flow rates causing inertial effects;
its porosity φ, equal to the ratio of the volume of the voids in the material to its total volume.

No current method allows a simultaneous determination of these three parameters using a single experiment. In particular, porosity is often measured separately from the two other parameters by a method using pycnometry (with helium, mercury, etc.) or weighing.

The permeability of a material can be measured with one of two types of methods: steady state or unsteady state. For example, see J. A. Rushing et al, Klinkenberg-corrected permeability measurements in tight gas sands: Steady-state versus unsteady-state techniques, SPE 89867 1-11, 2004.

The steady-state method has the disadvantage of requiring a rather long time to reach the stationary flow condition in order to acquire a measurement point. The time until such a stationary condition is reached varies with the inverse of k₁ and with the square of the sample thickness. It can easily be several hours for very low permeabilities. Separate determination of the intrinsic permeability k₁ and of the Klinkenberg coefficient b requires several measurement points, and therefore requires obtaining the same number of stationary states. This can take a long time, rendering this method poorly suited for low permeabilities. In addition, this technique requires measuring the fluid flow rate, which may be difficult when permeability is very low.

Measurement in a transient condition is preferable for overcoming these disadvantages. Typically, an experiment in an unsteady condition consists of recording the evolution of the differential pressure ΔP(t) between the ends of the sample. Each end of the sample is connected to a respective vessel, and one of them is initially subjected to a pressure pulse. This method is known as “Pulse decay”. A variant in which the downstream vessel has an infinite volume (the atmosphere) is known as “Draw down”.

The interpretation of ΔP(t) leads to identifying the permeability of the medium. Frequently, this technique does not consider the Klinkenberg effects.

In U.S. Pat. No. 2,867,116, a method of approximation was proposed for experimentally determining porosity, apparent permeability (i.e., including Klinkenberg effects) and intrinsic permeability. In this work, k₁, b and φ are approximated by conducting the same experiment three times with a constant ratio between the initial pressure pulse value and the initial pressure in the sample. The first experiment is conducted by noting the time required for the pressure pulse to decrease to a given fraction (e.g. 55%) of its initial value. The second experiment is identical to the first one, but is conducted by simply changing the pressure level of the pulse and the initial pressure in the sample such that the difference between them is the same as in the first experiment. The time for the pressure pulse to decrease to the same fraction (55%) of its initial value is again noted. The third experiment is identical to the first two, but the volume of the chamber used for generating the pressure pulse is modified. The values of k₁, b and φ are approximated from these three experiments, using a nomogram and taking advantage of an empirical linear behavior. It is hard to estimate the general true impact of these approximations. Moreover, the experimental difficulty related to the device and to the execution time required by conditioning the sample under different pressures should be noted.

In “A method for the simultaneous determination of permeability and porosity in low permeability cores”, SPE 15379. 1-11, 1988, S. E. Haskett et al propose a method for determining permeability k₁ and porosity φ, where Klinkenberg effects are neglected. The method requires that the experiment be conducted until the pressures in the upstream and downstream volumes have equalized. It is based on measuring the pressure difference over time between the upstream and downstream volumes. This configuration is not very precise and is not optimal for parameter determination.

In “A detailed analysis of permeability and Klinkenberg coefficient estimation from unsteady-state pulse-decay or draw-down experiments”, Symp. Soc. Core Analysts, Calgary, 10-13 September, 5CA2007-08. 2007, Y. Jannot et al re-examined the “Pulse decay” method without any specific simplifying assumptions: they simply considered that the sample constitutes a solid matrix that is non-deformable by the flow of the measurement gas, and that the gas flow is slightly compressible, isothermal, and creeping. In this context, the physical problem which describes the general case of the “Pulse decay” experiment is expressed by:

$$\frac{\partial }{\partial x} [ ( P + b ) \frac{\partial P}{\partial x} ] = \frac{φμ}{{k}_{l}} \frac{\partial P}{\partial t} for 0 < x < e and t > 0 \qquad ( 1 )$$

with the following initial conditions:

P(0.0)=P₀ᵢ (2)

P(x,0)=P₁ᵢ for x>0 (3)

and with the following boundary conditions:

$$\begin{matrix}\frac{{k}_{l} S}{μ {V}_{0}} [ P ( 0 , t ) + b ] \frac{\partial P}{\partial x} ( 0 , t ) = \frac{\partial P}{\partial t} ( 0 , t ) & ( 4 ) \\ \frac{{k}_{l} S}{μ {V}_{1}} [ P ( e , t ) + b ] \frac{\partial P}{\partial x} ( e , t ) = - \frac{\partial P}{\partial t} ( e , t ) & ( 5 )\end{matrix}$$

where:
P is the pressure at time t and at position x in the sample, x=0 corresponding to the upstream surface of the sample, x=e to its downstream surface, and the pressure pulse being applied at t=0
S is the cross-sectional area of the sample;
e is the length of the sample;
V₀ and V₁ are respectively the volumes of the upstream tank (high pressure) and of the downstream tank (low pressure) which are connected through the sample and which are initially (at t=0) at the respective pressures P₀ᵢ and P₁ᵢ;
μ is the dynamic viscosity of the gas, which is assumed to be constant.

In the “Draw down” configuration, the second boundary condition is replaced by a classic Dirichlet condition: P(e,t)=P₁=P₁ᵢ. It is assumed here that the sample is initially at the ambient pressure with which it is normally in equilibrium.

A dead volume is necessarily present upstream from the sample, between the valve which isolates the sample from the upstream tank and the upstream surface of the sample. It is desirable to have a very small volume V₀ (ideally close to the pore volume of the sample) in order to increase the sensitivity of the porosity φ measurements, but an accurate determination of this value for use in the condition (4) then becomes very difficult, as it is assumed that the dead volume is known with precision. The existence of this dead volume therefore has significant impact on the estimated values of k₁ and b. In addition, opening the valve when the “Pulse decay” experiment begins produces an expansion of the fluid into the dead volume, which causes visible thermal and hydrodynamic disturbances that are extremely difficult to incorporate accurately into a model. Equations (1) to (5) above do not integrate these thermal and hydrodynamic effects.

An error in the porosity value φ has a considerable impact on the estimated values for the permeability k₁ and Klinkenberg coefficient b. Thus, a good estimation of these two parameters requires an accurate knowledge of φ if this value is provided as an input parameter. The pycnometric techniques used for this purpose take time and merely lead to an estimate of intrinsic porosity and not effective porosity (storage coefficient), which is generally useful for analyzing an actual material.

There is a need for an experimental method that improves the estimation of the permeability k₁ and Klinkenberg coefficient b (for low permeabilities, replaced by the Forchheimer coefficient for high permeabilities). It is also desirable to be able to estimate porosity φ simultaneously in just one experiment.

### SUMMARY OF THE INVENTION

A method of estimating physical parameters of a material is hereby proposed, which comprises:
placing a sample of material in a sealed cell so that an upstream surface of the sample communicates with a first volume and that a downstream surface of the sample communicates with a second volume;
generating pressure modulation in the first volume;
measuring pressure variations over time in the first volume and in the second volume; and
using a differential equation, having as parameters the intrinsic permeability of the material, the porosity of the material, and at least one other coefficient of the material, and having as boundary condition the measured pressure variation in the first volume, to analyze numerically the measured pressure variation in the second volume in order to estimate at least the intrinsic permeability and said other coefficient.

To overcome the difficulties related to the dead volume upstream of the sample, the initial data is no longer considered to be solely the pressure pulse value P₀ᵢ serving to simulate the evolution of P(0,t) to perform the inversion. Instead, a tank is provided with a limited volume V₁ on the downstream side and two separate pieces of information are considered, both of them measured: the upstream pressure signal P(0,t)=P₀(t) and the downstream pressure signal P(1,t)=P₁(t). The signal P₀(t) may serve as the input signal for the analysis step which consists of numerical inversion of the differential equation, performed on the downstream signal P₁(t). Since P₀(t) is no longer simulated, but measured, it may include irregularities related to thermal events, to the existence of a dead volume, etc., without this being a source of interference compared to the model used in the inversion procedure.

The other coefficient specific to the material and estimated in conjunction with its intrinsic permeability k₁ is typically the Klinkenberg coefficient b if it is known that the material being analyzed is of low permeability (lower than 10⁻¹⁶ m²). If the permeability is in a higher range, the other coefficient may be the Forchheimer coefficient β. There may exist a range of permeabilities where both the Klinkenberg coefficient B and Forchheimer coefficient β can be included in the model.

In the case where the Klinkenberg coefficient b is estimated with the intrinsic permeability k₁, the analysis step consists of the numerical inversion of (1) performed on the downstream signal P₁(t). The boundary condition (4) is replaced by a Dirichlet pressure condition P(0,t)=P₀(t), where P₀(t) is measured using a pressure gauge in the first volume V₀. The physical problem no longer depends on V₀ or on a dead volume which therefore no longer needs to be known.

The pressure modulation in the first volume is not simply applied instantaneously, but over a time scale larger than a pressure pulse. It is typically done over a time scale which depends on the permeability range of the material, generally greater than a minute. This pressure modulation in the first volume may in particular be caused by a succession of pressure pulses.

In one embodiment, the numerical analysis of the measured pressure variations includes monitoring the evolution over time of the reduced sensitivity of the measured pressure P₁(t) in the second volume to the intrinsic permeability and the evolution over time of the reduced sensitivity of P₁(t) to the Klinkenberg or Forchheimer coefficients. This verifies that the pressure modulation has been applied to the first volume in such a way that it does not allow the ratio between these two sensitivities to stabilize, as this would prevent proper estimation of the permeability and of the coefficient in question.

In a preferred embodiment, the numerical analysis of the measured pressure variations P₀(t), P₁(t) is performed so that the porosity φ of the material is estimated in addition to its intrinsic permeability k₁ and its Klinkenberg coefficient b (or Forchheimer coefficient β).

In a classic “Pulse decay” experiment, the sensitivity of P₁(t) at φ rapidly becomes constant after too short a time for this parameter to be estimated correctly. To increase this sensitivity, one can multiply the effects from short periods so that the accumulation of fluid in the pores of the material occurs repeatedly for the duration of the experiment. As the method includes a measurement of P₀(t) which becomes data for the inversion performed on P₁(t), any imposed variation of P₀(t) is possible. A succession of pressure pulses upstream of the sample is therefore generated, exciting the capacitive behavior of the system in order to facilitate the porosity estimation.

The numerical analysis of the measured pressure variations may include monitoring the evolution over time of the reduced sensitivity of the measured pressure P₁(t) to porosity. This allows verifying that the pressure modulation has been applied in the first volume in a manner that does not allow this reduced sensitivity to porosity to stabilize, because this would prevent properly estimating the porosity φ.

In order to enhance convergence of the parameter estimation, in certain cases the intrinsic permeability k₁ and Klinkenberg coefficient b may be pre-estimated using pressures measured during time intervals where the pressure in the second volume varies in an essentially linear manner.

An advantageous embodiment comprises an examination of the evolution over time of the pressure in the second volume. If this examination shows that the pressure in the second volume varies over time in a substantially linear manner, this pressure is allowed to vary in a substantially linear manner in order to acquire values for pre-estimating the intrinsic permeability and the coefficient, and then applying a new pressure pulse in the first volume.

### BRIEF DESCRIPTION OF THE FIGURES

Other features and advantages of the invention will be apparent from the following description of a non-limiting example of an embodiment, with reference to the attached drawings in which:

FIG. 1 is a diagram of an installation usable for implementing a method for estimating physical parameters according to the invention;

FIG. 2 is a graph which shows reduced sensitivities to permeability, to the Klinkenberg coefficient, and to porosity in one embodiment of the method;

FIG. 3 is a graph which shows the simulated evolution in pressure downstream of the sample in an exemplary use of the method;

FIG. 4 is a graph which shows the evolution in reduced sensitivities to permeability, to the Klinkenberg coefficient, and to porosity in the example of FIG. 3;

FIG. 5 is a graph which shows the evolution in the ratio between the reduced sensitivities to permeability and to the Klinkenberg coefficient in the example of FIG. 3;

FIG. 6 is a graph which shows the evolution of the ratio between the reduced sensitivities to permeability and to porosity in the example of FIG. 3;

FIGS. 7 to 10 are graphs similar to those in FIGS. 3 to 6 in another exemplary use of the method;

FIGS. 11 to 14 are graphs similar to those in FIGS. 3 to 6 in yet another exemplary use of the method;

FIGS. 15 and 16 are graphs which show the evolution in simulated pressures upstream and downstream of the sample in a test case of the method;

FIGS. 17 and 18 are graphs which show the evolution in measured pressures upstream and downstream of the sample in a test on a pine wood sample;

FIG. 19 is a graph which shows the pressure residual downstream of the sample in the test in FIGS. 17 and 18, where the residual is the difference between the pressure calculated by a model which describes the physics of the test and the pressure measured during the test;

FIGS. 20 to 22 are graphs similar to those in FIGS. 17 to 19 in an initial test on a rock sample;

FIGS. 23 to 25 are graphs similar to those in FIGS. 17 to 19 in a second test on the same rock sample;

FIGS. 26 to 28 are graphs similar to those in FIGS. 17 to 19 in a third test on the same rock sample.

### DETAILED DESCRIPTION OF THE DRAWINGS

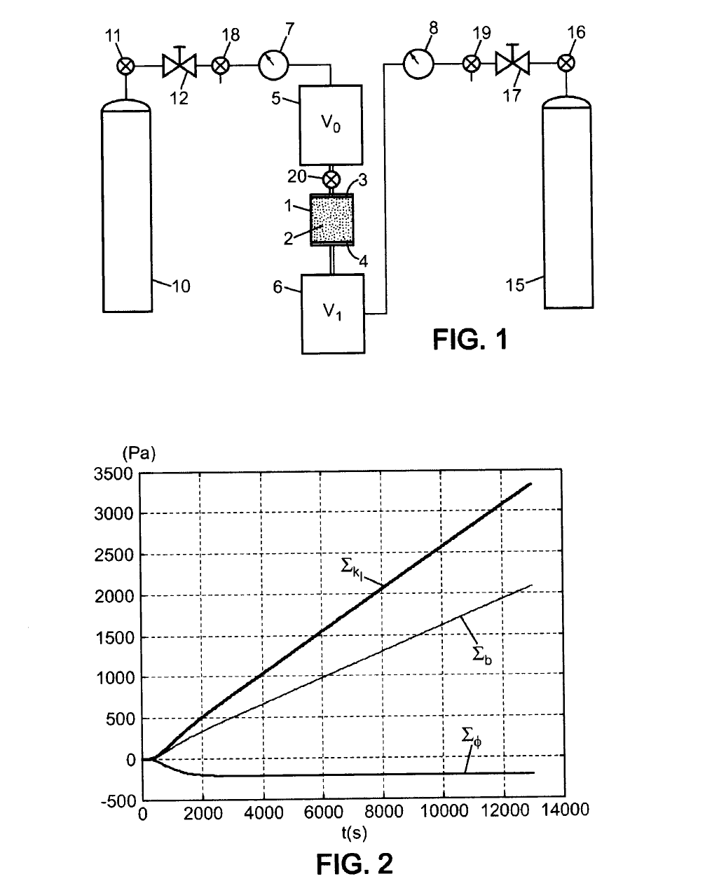

The installation represented in FIG. 1 comprises a Hassler cell, in which a sample 2 of material is placed in order to determine its physical parameters in the presence of a flow of fluid. The fluid used may be a gas such as nitrogen or helium, but this is in no way limiting.

In a known manner, the Hassler cell is in the form of a sleeve in which the sample 2, which has a cylindrical shape of cross-sectional area S and length e, is hermetically sealed in order to force the gas to flow through the porous structure of the material. The sample 2 has an upstream surface 3 and a downstream surface 4 which communicate with two tanks 5 and 6 having respective volumes denoted V₀ and V₁.

Pressure gauges 7 and 8 allow measuring the pressures in tanks 5 and 6. The gas which flows through the sample comes from a bottle 10 connected to the upstream volume V₀ by means of valve 11 and pressure regulator 12. On the downstream side, the volume V₁ is connected to a collection bottle 15 by means of valve 16 and pressure regulator 17. Additional valves 18, 19 are placed between pressure regulator 12 and upstream volume V₀ and between pressure regulator 17 and downstream volume V₁ to allow selective communication of pressure regulators with tanks 5 and 6.

Another valve 20 is placed between upstream tank 5 and the Hassler cell 1 in order to trigger the pressure pulses at the upstream surface 3 of the sample. In order to apply a first pressure pulse to the sample 2, valve 19 is positioned to bring downstream tank 6 to an initial pressure P₁ᵢ (for example atmospheric pressure), valve 20 being closed. As soon as pressure equilibrium is achieved, valve 19 is closed. Valves 11 and 18 are opened and pressure regulator 12 is set to the desired pressure pulse value. The upstream volume V₀ is thus filled with gas at the desired pressure. Valve 18 is then closed and valve 20 is opened in order to apply the pressure pulse to sample 2. Using pressure gauges 7 and 8, the pressure reduction in upstream volume V₀ and the pressure increase in downstream volume V₁ can then be observed. The measured evolution of pressures P₀(t) and P₁(t) is then recorded for numerical analysis. To apply a subsequent pressure pulse to sample 2, pressure regulator 12 is set to the new desired pressure value, then valve 18 is opened to fill volume V₀ to the desired pressure and is closed again.

Prior to applying the first pressure pulse, with valve 20 closed, sample 2 is in equilibrium with downstream volume V₁ so that the initial condition (3) is met. If the Forchheimer effects can be ignored, the physical problem to be solved for estimating the parameters is then the following problem (1)-(3)-(4′)-(5):

$$\frac{\partial }{\partial x} [ ( P + b ) \frac{\partial P}{\partial x} ] = \frac{φμ}{{k}_{l}} \frac{\partial P}{\partial t} for 0 < x < e and t > 0 \qquad ( 1 )$$

with the initial condition:

P(x,0)=P₁ᵢ for x>0 (3)

and the boundary conditions:

$$\begin{matrix}P ( 0 , t ) = {P}_{0} ( t ) for t \geq 0 & ( 4 ' ) \\ \frac{{k}_{l} S}{μ {V}_{1}} [ P ( e , t ) + b ] \frac{\partial P}{\partial x} ( e , t ) = - \frac{\partial P}{\partial t} ( e , t ) & ( 5 )\end{matrix}$$

In the expression for this problem, the pressure P₀(t) upstream from sample 2 is a data item. The physical parameters of the material of sample 2 that intervene in the system are its porosity φ, its intrinsic permeability k₁, and its Klinkenberg coefficient b.

The feasibility of estimating parameters from a signal f(t) may be studied by means of a sensitivity study. In our case, we can for example examine the signal f(t)=P₁(t). The sensitivity of f(t) to a parameter ψ to be estimated is defined by

$$\frac{\partial f ( t )}{\partial ψ} .$$

For practical reasons, the reduced sensitivity

$${Σ}_{ψ} = ψ \frac{\partial f ( t )}{\partial ψ}$$

is used instead, which allows obtaining those quantities in units of pressure. Analysis of the evolution of these quantities over time allows diagnosing the possibility of estimating the parameter ψ from the signal f(t). This estimation is possible if
the variations of

$${Σ}_{ψ} = ψ \frac{\partial f ( t )}{\partial ψ}$$

are significant over a time interval that is sufficiently large relative to the sampling time step of the signal. Significant is understood to mean that Σ_{ψ} is higher that the precision of the measurement tool (pressure sensors 7 and 8) used to read f(t);
if multiple parameters are sought (for example k₁, b, or even φ), the reduced sensitivities to all these parameters must be uncorrelated, which implies that they are not proportional to each other. Otherwise the variations observed in f(t) cannot be independently attributed to a specific parameter, making it impossible to estimate them simultaneously from a single signal f(t).

FIG. 2 shows the evolution over time in the reduced sensitivities to permeability k₁ to the Klinkenberg coefficient b, and to porosity 4, calculated for the case of a single pressure pulse (“Pulse decay” type) under the following conditions: k₁=10⁻¹⁹ m², b=13.08 bar, φ=0.02, e=5 cm, sample diameter d=5 cm, V₀=10⁻³ m³, V₁=2.5×10⁻³ m³ with an initial pressure of 15 bar in the upstream volume V₀ and 1 bar in the downstream volume V₁. These sensitivities were calculated from signals P₁(t) simulated using the physical model (1)-(3)-(4′)-(5). It was observed that after a several tens of minutes, the reduced sensitivity Σ_{φ} to porosity stabilizes such that, after this period, the pressure measurements are no longer indicative of the porosity value φ. Measurements conducted under the conditions of FIG. 2 may therefore be insufficient for determining porosity φ. They may, however, be appropriate for determining permeability k₁ and the Klinkenberg coefficient b if the porosity value φ is also known. These estimations of k₁ and b are obtained without having to determine with precision V₀ and the dead volume associated with the upstream side of sample 2, and avoids problems from any irregularities in P₀(t) which, having been measured, no longer need to be calculated.

In order to increase sensitivity to porosity φ and allow its estimation, it is advisable to multiply the effects from short periods so that the accumulation of gas in the pores of the material occurs repeatedly for the entire duration of the experiment. This is illustrated below using three examples.

### Example 1

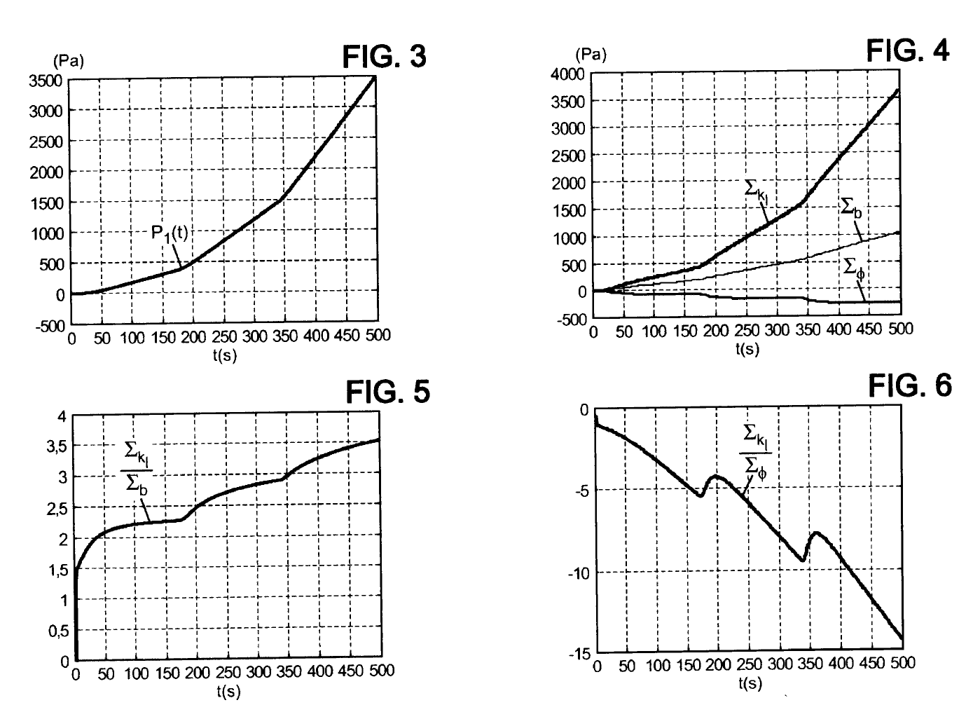

### FIGS. 3-6

In this example, the sensitivity analysis is conducted in a simulation on a material with intrinsic permeability k₁=10⁻¹⁷ m², Klinkenberg coefficient b=2.49 bar, porosity φ=0.02, for an experiment duration of t_{f}=500 s. Three pressure pulses are applied successively—the first one being 5 bar at t=0, the second one being 10 bar at t=t_{f}/3, and the third one being 15 bar at t=2t_{f}/3. The volume of upstream tank 5 is V₀=10⁻³ m³ and the volume of downstream tank 6 is V₁=2.5×10⁻³ m³.

FIG. 3 shows the evolution over time of the pressure P₁(t) downstream of the sample. FIG. 4 shows the evolution over time of the reduced sensitivities Σₖ_{₁}, Σ_{b} and Σ_{φ} of the pressure P₁(t) to intrinsic permeability k₁, to the Klinkenberg coefficient b, and to porosity φ. FIG. 5 shows the evolution over time of the ratio between the reduced sensitivities Σₖ_{₁}, Σ_{b} to intrinsic permeability k₁ and to the Klinkenberg coefficient b. FIG. 6 shows the evolution over time of the ratio between the reduced sensitivities Σₖ_{₁}, Σ_{φ} to intrinsic permeability k₁ and to porosity φ.

### Example 2

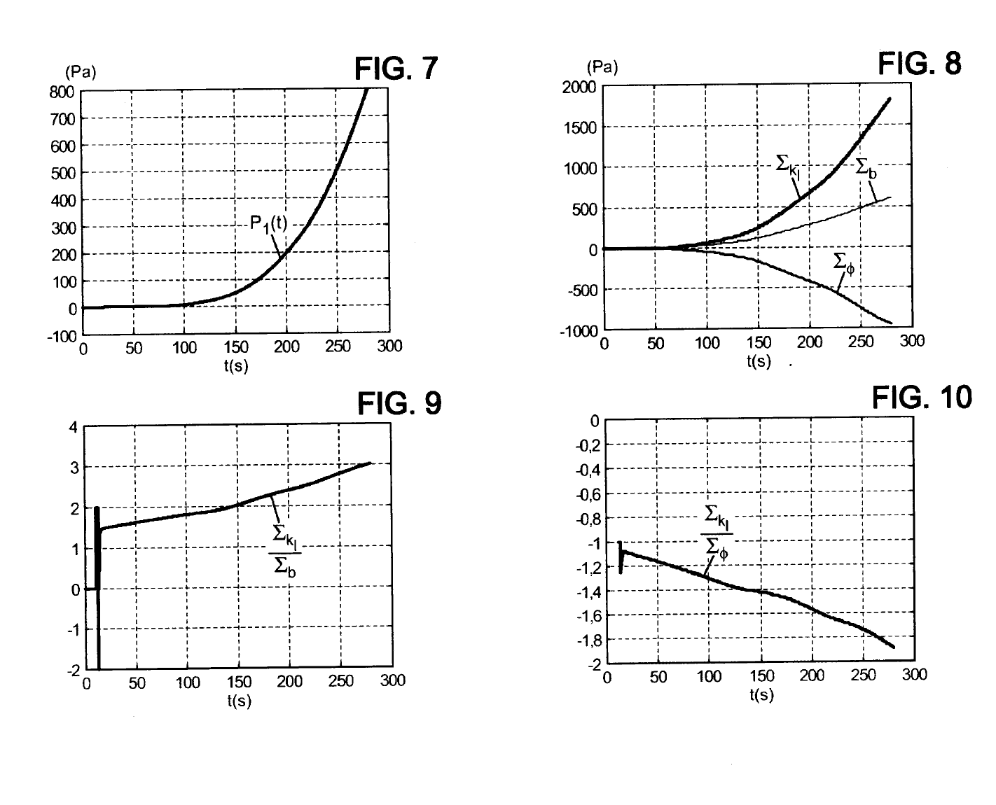

### FIGS. 7-10

In this example, the sensitivity analysis is conducted under the same conditions used in Example 1 for a material with intrinsic permeability k₁=10⁻¹⁷ m², Klinkenberg coefficient b=2.49 bar, porosity φ=0.1, for an experiment duration of t_{f}=200 s. FIGS. 7 to 10 are graphs for Example 2 that are similar to those in FIGS. 3 to 6.

### Example 3

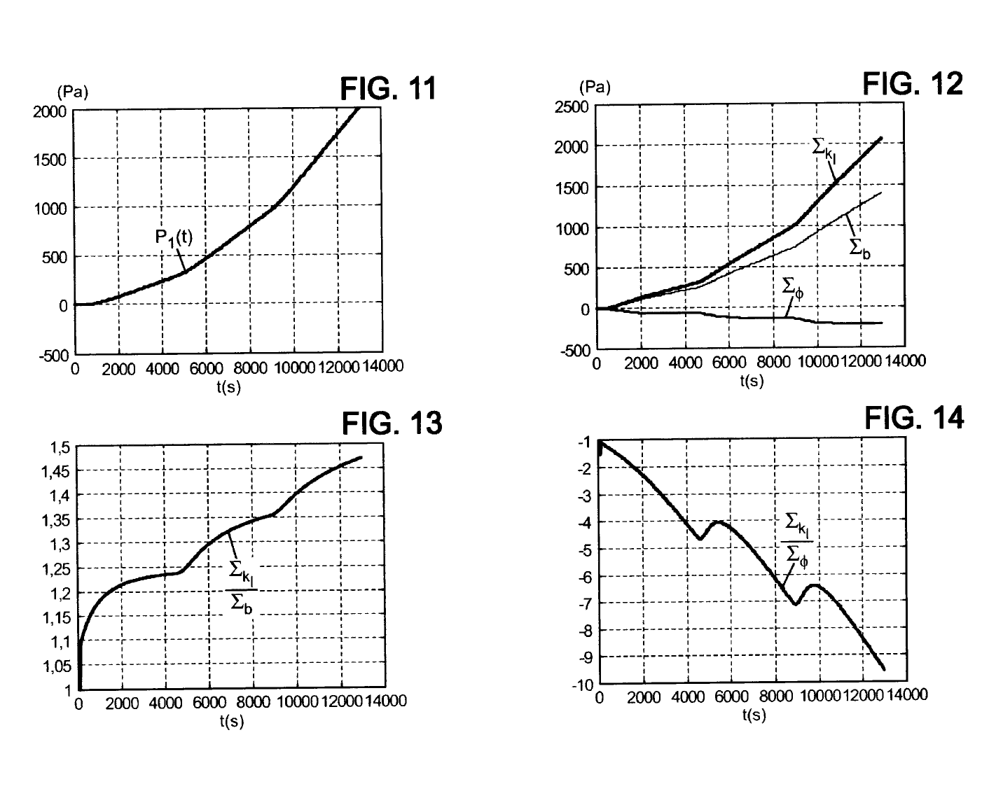

### FIGS. 11-14

In this example, the sensitivity analysis is conducted under the same conditions used in Examples 1 and 2 for a material with intrinsic permeability k₁=10⁻¹⁹ m², Klinkenberg coefficient b=13.08 bar, porosity φ=0.02, for an experiment duration of t_{f}=13,000 s. FIGS. 11 to 14 are graphs for Example 3 that are similar to those in FIGS. 3 to 6.

These three examples show, for three different materials, that the pressure increases P₁(t) downstream from the sample are measurable quantities even if a relatively large volume V₁ (2.5 liters) is chosen. A very large volume was deliberately chosen in order to emphasize the fact that the relative error in the measurement can be minimized. Choosing a smaller volume leads to more significant increases and it can be verified that the sensitivities are not affected. Unlike in the “draw down method”, selecting a larger volume for V₁ does not cause a wide variation in the average pressure over time. In fact, the average pressure variation, which is quite significant, here results from the successive pressure pulses.

In all cases, the sensitivities are quite significant and properly decorrelated from each other. This allows simultaneous estimation of the three parameters k₁, b and φ. By comparing FIG. 4, 8 or 12 with FIG. 2, one can see that modulating the upstream pressure with multiple successive pulses clearly improves sensitivity to porosity φ, thus facilitating its estimation.

In order to illustrate the method's ability to estimate the three parameters k₁, b and φ simultaneously, a series of tests was conducted based on signals generated numerically using the physical model with P₀ᵢ=1 bar. Random noise given by δP₀=0.01×dP×s×P₀ₘₐₓ/3 and δP₁=0.01×dP×s×P₁ₘₐₓ/3 was superimposed onto two simulated signals P₀(t) and P₁(t) in order to better represent an actual measurement. This noise is such that ‘s’ is a random number with a standard deviation of 1 and ‘dP’ is the error on P₀(t) and P₁ (t) (as a % of the measurement). The coefficient 3 was set so that the intervals P₀(t)±δP₀ and P₁(t)±P₁ included 99.7% of the values if they had actually been measured. In these simulations, dP=0.1% was used as this is a typical value for a pressure sensor, except for cases 14, 15 and 16 in which dP=1% was used.

TABLE I

| | kₗ | b | φ | V₀ | V₁ | p₀ᵢ | | | t_{f} | |
|---|---|---|---|---|---|---|---|---|---|---|
| Case No. | (m²) | (bar) | (%) | (m³) | (m³) | (bar) | dp (%) | N | (s) | M |
| 1 | 10⁻¹⁷ | 2.49 | 0.02 | 10⁻⁵ | 10⁻² | 3 | 0.1 | 1000 | 1000 | 200 |
| 2 | 10⁻¹⁷ | 2.49 | 0.02 | 10⁻² | 10⁻² | 3 | 0.1 | 1000 | 1000 | 200 |
| 3 | 10⁻¹⁷ | 2.49 | 0.02 | 10⁻⁵ | 10⁻² | 3 | 0.1 | 100 | 1000 | 200 |
| 4 | 10⁻¹⁷ | 2.49 | 0.02 | 10⁻⁵ | 10⁻² | 3 | 0.1 | 1000 | 300 | 200 |
| 5 | 10⁻¹⁷ | 2.49 | 0.02 | 10⁻⁵ | 10⁻² | 3 | 0.1 | 1000 | 1000 | 50 |
| 6 | 10⁻¹⁷ | 2.49 | 0.1 | 10⁻⁵ | 10⁻² | 3 | 0.1 | 1000 | 1000 | 200 |
| 7 | 10⁻¹⁷ | 13.08 | 0.02 | 10⁻⁵ | 10⁻² | 3 | 0.1 | 1000 | 100000 | 200 |
| 8 | 10⁻¹⁷ | 2.49 | 0.02 | 10⁻² | 10⁻⁴ | 3 | 0.1 | 1000 | 1000 | 200 |
| 9 | 10⁻¹⁷ | 2.49 | 0.1 | 10⁻² | 10⁻⁴ | 3 | 0.1 | 1000 | 1000 | 200 |
| 10 | 10⁻¹⁹ | 13.08 | 0.02 | 10⁻² | 10⁻⁴ | 3 | 0.1 | 1000 | 10000 | 200 |
| 11 | 10⁻¹⁹ | 13.08 | 0.02 | 10⁻² | 10⁻⁴ | 5 | 0.1 | 1000 | 10000 | 200 |
| 12 | 10⁻¹⁷ | 2.49 | 0.02 | 10⁻² | 10⁻⁴ | 3 | 1 | 1000 | 1000 | 200 |
| 13 | 10⁻¹⁷ | 2.49 | 0.1 | 10⁻² | 10⁻⁴ | 3 | 1 | 1000 | 1000 | 200 |
| 14 | 10⁻¹⁹ | 13.08 | 0.02 | 10⁻² | 10⁻⁴ | 5 | 1 | 1000 | 10000 | 200 |

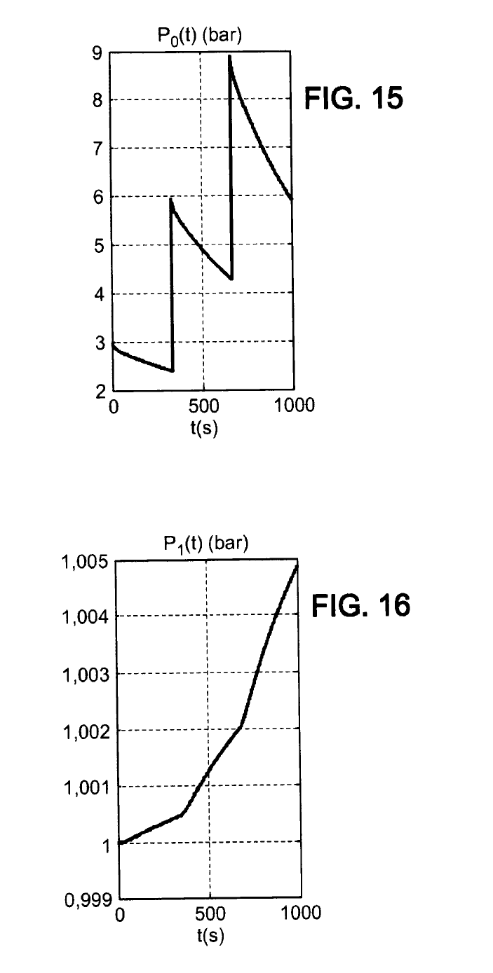

The parameters used in the tests series are indicated in Table I, and they include the number N of pressure measurement points NO and P₁(t), experiment duration t_{f}, and the number M of spatial discretization steps for the thickness e of the sample used for the inversion of the problem (1)-(3)-(4′)-(5). In each case, three pressure pulses were applied at times 0, t_{f}/3 and 2t_{f}/3, bringing the pressure in the upstream tank to P₀ᵢ, 2P₀ᵢ and 3P₀ᵢ. The pressure modulation adopted in this test series makes it possible to describe the measurement method in this case as “Step Decay”. FIGS. 15 and 16 summarize (in bars) the evolution in pressures P₀(t) and P₁(t) upstream and downstream of the sample in case no. 1.

The results of these inversions are show in Table II, with the % deviations dk₁, db, dφ between the initial values of k₁, b and φ and the values obtained by the inversion calculations.

TABLE II

| Case | kₗ | dkₗ | b | db | φ | dφ |
|---|---|---|---|---|---|---|
| No. | (m²) | (%) | (bar) | (%) | (%) | (%) |
| 1 | 1.007 · 10⁻¹⁷ | 0.10 | 2.456 | 0.26 | 1.96 | 0.28 |
| 2 | 1.003 · 10⁻¹⁷ | 0.11 | 2.469 | 0.34 | 1.97 | 0.50 |
| 3 | 1.067 · 10⁻¹⁷ | 0.61 | 2.159 | 1.70 | 1.60 | 2.00 |
| 4 | 1.005 · 10⁻¹⁷ | 0.09 | 2.460 | 0.31 | 1.98 | 0.21 |
| 5 | 1.006 · 10⁻¹⁷ | 0.10 | 2.460 | 0.26 | 1.97 | 0.28 |
| 6 | 1.007 · 10⁻¹⁷ | 0.09 | 2.454 | 0.28 | 9.93 | 0.18 |
| 7 | 1.030 · 10⁻¹⁹ | 0.31 | 12.55 | 0.44 | 1.96 | 0.25 |
| 8 | 1.004 · 10⁻¹⁷ | 0.11 | 2.460 | 0.35 | 1.95 | 0.53 |
| 9 | 1.002 · 10⁻¹⁷ | 0.08 | 2.472 | 0.38 | 9.95 | 0.38 |
| 10 | 1.027 · 10⁻¹⁹ | 0.21 | 12.58 | 0.47 | 1.96 | 0.30 |
| 11 | 1.007 · 10⁻¹⁹ | 0.21 | 13.08 | 0.37 | 2.00 | 0.30 |
| 12 | 1.001 · 10⁻¹⁷ | 1.07 | 2.49 | 3.47 | 2.06 | 5.11 |
| 13 | 1.003 · 10⁻¹⁷ | 0.81 | 2.42 | 3.85 | 9.67 | 3.81 |
| 14 | 1.088 · 10⁻¹⁹ | 1.81 | 11.24 | 3.37 | 1.78 | 2.99 |

These results lead to the following conclusions:
The precision of these estimations is excellent (often better than 1%) for the three parameters estimated and remains completely acceptable with a measurement noise of 1% of the maximum pressure value (cases 12 to 14).
Precision has little dependency on volume V₀. A volume of 0.1 to 10 liters, preferably 0.1 to 1 liter, is quite suitable;
The volume V₁ must be selected so that the pressure increase is sufficient to be measured with good precision. A value of 0.1 liter provides satisfactory results for the materials examined and is sufficiently high to limit error due to a dead volume downstream. In general a volume V₁ of 0.05 to 10 liters could be used;
Working with higher pressure levels (5, 10 and 15 bar) results in better precision for the case where b=13.08 bar;
A number of 1,000 experimental points seems to be adequate, as precision drops somewhat if this number is reduced to 100 (Case 3).
Extending the experiment's duration beyond a certain limit does not significantly improve precision (comparison of Cases 7 and 10).
Acceptable measurement periods for estimating the three parameters are 20 minutes for k₁ around 10⁻¹⁷ m² and 3 hours for k₁ around 10⁻¹⁹ m². It is generally advisable to apply pressure modulation in the first volume over a time scale of a few tens of minutes to a few hours, and in all cases for more than one minute. One will note that pressure modulation by a series of pulses is a specific case and that other forms of modulation over a sufficient time scale may be appropriate for the invention, given that the upstream pressure profile P₀(t), which is measured, may be of any form.

A relatively large volume V₀ offers the advantage of little variation in the pressure P₀(t) between two pulses. In addition, if a large enough volume V₁ is selected so that the pressure increase is not very significant in comparison to P₀, then the experiment occurs within fairly steady (quasi stationary) conditions. Under these conditions, a good pre-estimation can be obtained by simple linear regression over the portions of P₁(t) corresponding to each pressure pulse. Having a good pre-estimation ensures easier convergence of the estimation over the entire signal with the complete model.

The execution of the experiment can be automated. In fact, the appearance of a linear or quasi-linear regime for P₁(t) for each pressure pulse (FIG. 16) corresponds to a quasi-stationary regime with a loss of sensitivity of P₁(t) to porosity φ (by definition, in a quasi-stationary regime, the effect of accumulation in the sample's pores disappears). The experiment can therefore be conducted in such a way that each pressure pulse has a duration which allows P₁(t) to achieve quasi-linear behavior over time. This quasi-linear regime is allowed to last for a brief period in order to obtain a good pre-estimation of k₁ and b. Using large enough volumes V₀ and V₁ thus allows direct control of the experiment in order to optimize the total duration while obtaining properly convergent results.

Laboratory tests were conducted with V₀=1.02×10⁻³ m³ and V₁=2.26×10⁻³ m³ and the following experimental protocol:

place sample 2 in Hassler cell 1;

pressurize outer chamber of the Hassler cell;

close valve 20, wait for equilibrium;

open valve 18 and adjust pressure regulator 12 to obtain P₀=P₀ᵢ₁

start recording pressures P₀(t) and P₁(t);

close valve 18 and open valve 20;

adjust pressure regulator 12 to obtain P₀=P₀ᵢ₂;

after time t₁, open valve 18 for a few seconds;

adjust pressure regulator 12 to obtain P₀=P₀ᵢ₃;

after time t₂, open valve 18 for a few seconds;

after time t₃ stop recording data, open valve 19 and remove sample 2.

In some of these tests, the permeability k₁ and the Klinkenberg coefficient b were pre-estimated as follows:
estimate the slopes for the three portions of the curves P₁(t) which are comparable to lines corresponding to the successive pressure pulses;
deduce three values for the apparent permeability k_{g}. Used for these calculations are values of P₀ and P₁ equal to half the sum of the end values of each interval;
plot the values of k_{g} as a function of 1/P_{avg}=2/(P₀+P₁) and by linear regression obtain a classic pre-estimation of k₁ and b, knowing that k_{g}=k₁.(1+b/P_{avg}).

These pre-estimated values of k₁ and b are then used as initial values for the final estimation of k₁, b and φ by inversion performed on the complete signal P₁(t), signal P₀(t) being input data, using the physical model (1)-(3)-(4′)-(5).

### Example 4

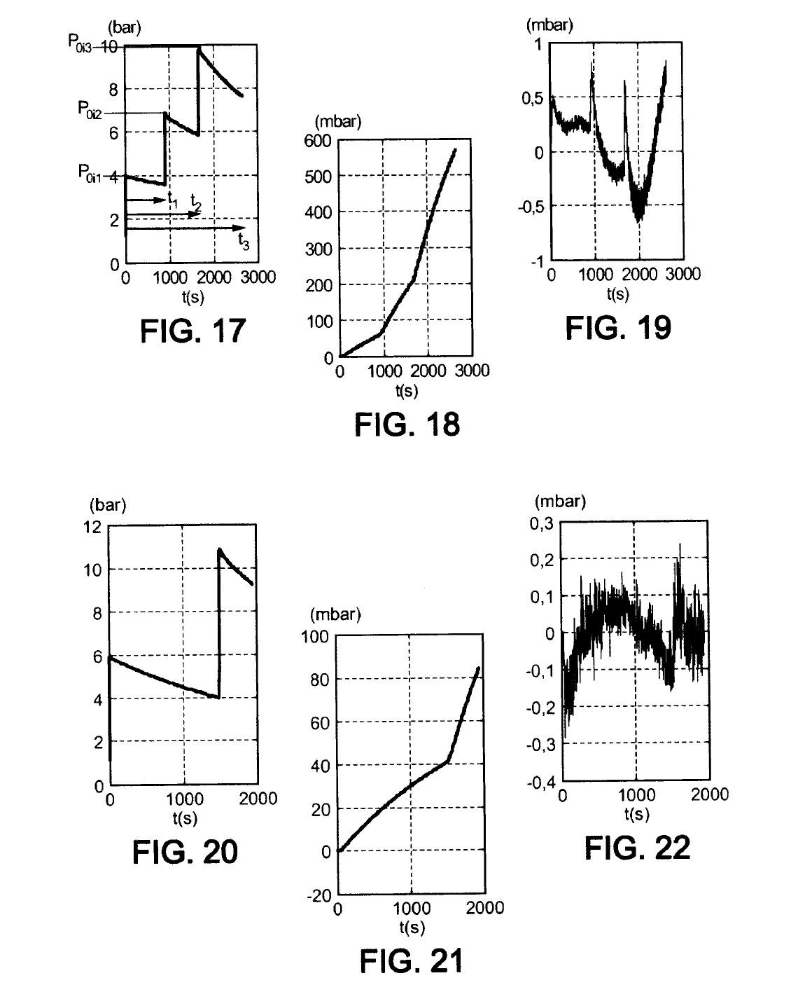

### FIGS. 17-19

Two tests were conducted according to the above experimental protocol, on a pine wood sample having dimensions d=38.5 mm and e=60 mm. The porosity of the sample (without constraints) measured by pycnometry was φ=0.27.

In the second test, the permeability k₁ and the Klinkenberg coefficient b were pre-estimated as 1.76×10⁻¹⁶ m² and 0.099 bars. The final results of the estimation are shown in Table III, with the relative standard deviations σₖ_{₁}, σ_{b} and σ_{φ} for the three parameters estimated simultaneously.

TABLE III

| Test | kₗ | σₖₗ | b | σ_{b} | | σ_{φ} |
|---|---|---|---|---|---|---|
| No. | (m²) | (%) | (bar) | (%) | φ | (%) |
| 1 | 1.64 · 10⁻¹⁶ | 0.045 | 0.230 | 0.98 | 0.257 | 0.38 |
| 2 | 1.70 · 10⁻¹⁶ | 0.038 | 0.187 | 1.14 | 0.252 | 0.39 |

Evolutions in the pressures P₀(t) measured in bars and ΔP₁(t)=P₁(t)−P₁(0) in millibars are represented in FIGS. 17-18. FIG. 19 shows the residual of P₁(t) in millibars, after the estimation. These estimations are of excellent quality, as proven by the measured and estimated P₁(t) curves and especially the pressure residual curve, and as confirmed by the low standard deviations σₖ_{₁}, σ_{b} and σ_{φ}.

### Example 5

### FIGS. 20-28

Three tests were conducted according to the above experimental protocol, on a rock core of dimensions d=38 mm, e=60.3 mm. The core porosity (without constraints) measured by pycnometry was φ=0.06.

Permeability k₁ and the Klinkenberg coefficient b were pre-estimated as 3.34×10⁻¹⁷ m² and 1.47 bars in the second test, and 3.86×10⁻¹⁷ m² and 0.97 bars in the third test. The final results of the estimation are indicated in Table IV.

TABLE IV

| Test | kₗ | σₖₗ | b | σ_{b} | | σ_{φ} |
|---|---|---|---|---|---|---|
| No. | (m²) | (%) | (bar) | (%) | φ | (%) |
| 1 | 3.41 · 10⁻¹⁷ | 0.058 | 1.57 | 0.18 | 0.055 | 0.23 |
| 2 | 3.51 · 10⁻¹⁷ | 0.023 | 1.41 | 0.11 | 0.055 | 0.28 |
| 3 | 3.77 · 10⁻¹⁷ | 0.052 | 1.16 | 0.41 | 0.048 | 1.13 |

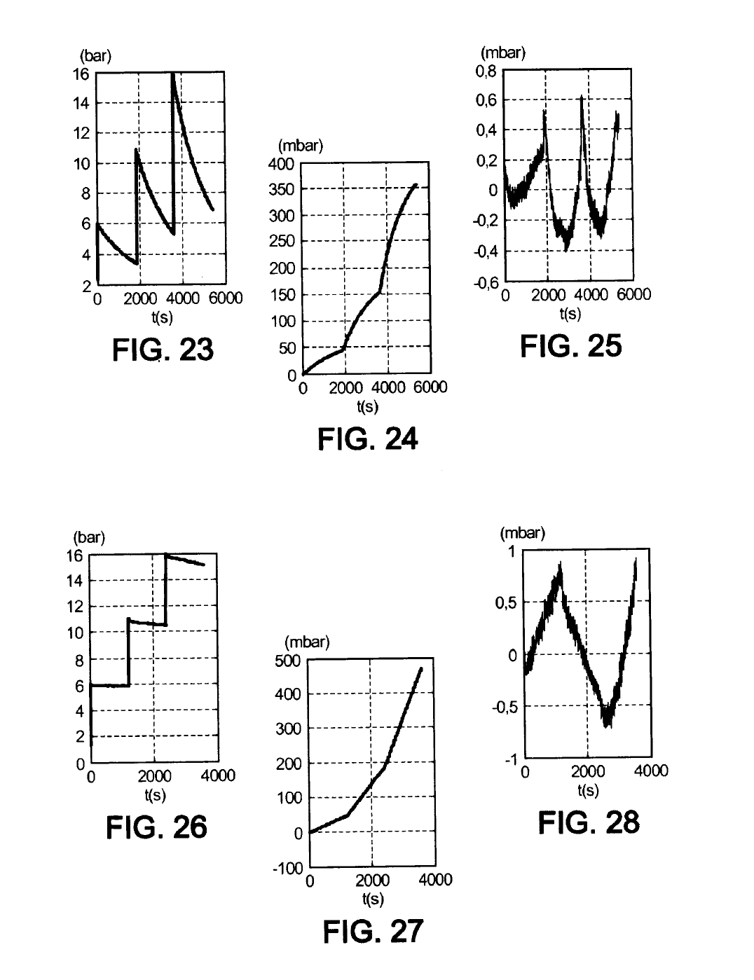

The evolutions in the pressures P₀(t) measured in bars and ΔP₁(t)=P₁(t)−P₁(0) in millibars are represented in FIGS. 20-21 for the first test, in FIGS. 23-24 for the second test, and in FIGS. 26-27 for the third test. The residuals for P₁(t) after the estimation, in millibars, are indicated in FIG. 22 for the first test, in FIG. 25 for the second test, and in FIG. 28 for the third test. Here again the estimations are of excellent quality, as proven by the measured and estimated curves P₁(t) and the pressure residual curves, and as confirmed by the low standard deviations σₖ_{₁}, σ_{b} and σ_{φ}.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A method of estimating physical parameters of a porous material with respect to a flow, said method comprising:
placing a sample of material in a sealed cell so that an upstream surface of the sample communicates with a first volume and that a downstream surface of the sample communicates with a second volume;
generating pressure modulation in the first volume;
measuring respective pressure variations in the first and second over time; and
using a differential equation, having as parameters the intrinsic permeability of the material, the porosity of the material, and at least another coefficient of the material, and as boundary condition the measured pressure variation in the first volume, analyzing numerically the measured pressure variation in the second volume in order to estimate at least the intrinsic permeability and said other coefficient.

2. The method of claim 1, wherein pressure modulation in the first volume is applied over a time scale larger than that of a pressure pulse.

3. The method of claim 1, wherein pressure modulation in the first volume is applied over a time scale larger than one minute.

4. The method of claim 1, wherein pressure modulation in the first volume is generated by a series of pressure pulses.

5. The method of claim 1, wherein the numerical analysis of the measured pressure variations comprises monitoring the evolution over time of a reduced sensitivity of the pressure measured in the second volume to the intrinsic permeability and the evolution over time of a reduced sensitivity of the pressure measured in the second volume to said other coefficient.

6. The method of claim 1, wherein the numerical analysis of the measured pressure variations is carried out so as to further estimate porosity of the material.

7. The method of claim 6, wherein the numerical analysis of the measured pressure variations comprises monitoring the evolution over time of the reduced sensitivity of the pressure measured in the second volume to porosity.

8. The method of claim 1, wherein the numerical analysis of the measured pressure variations comprises, in time intervals where the pressure in the second volume varies in a substantially linear manner, a pre-estimation of intrinsic permeability and of said coefficient to enhance convergence of the estimation.

9. The method of claim 8, wherein the evolution over time of the pressure in the second volume is examined and, when it is observed that the pressure in the second volume varies in a substantially linear manner over time, allowing said pressure to vary in a substantially linear manner in order to acquire values for pre-estimating the intrinsic permeability and said coefficient, and then applying a new pressure pulse in the first volume.

10. The method of claim 1, wherein the first volume is between 0.1 and 10 liters.

11. The method of claim 1, wherein the second volume is between 0.05 and 10 liters.

12. The method of claim 1, wherein said other coefficient comprises a Klinkenberg coefficient.

13. The method of claim 1, wherein said other coefficient comprises a Forchheimer coefficient.
